(19) United States
(12) Patent Application Publication
(10) Pub. No.: US 2026/0269130 A1
(43) Pub. Date: Sep. 10, 2026

(54) MULTILAYER ELECTRONIC COMPONENT

(71) Applicant: SAMSUNG ELECTRO-MECHANICS CO., LTD., Suwon-si (KR)

(72) Inventors: Yeong Lim KWON, Suwon-si (KR); Se Hun PARK, Suwon-si (KR)

(73) Assignee: SAMSUNG ELECTRO-MECHANICS CO., LTD., Suwon-si (KR)

(21) Appl. No.: 19/532,290

(22) Filed: Feb. 6, 2026

(30) Foreign Application Priority Data
Mar. 7, 2025 (KR) 10-2025-0030057

(51) Int. Cl. H01G 4/232; H01G 4/008; H01G 4/012; H01G 4/12; H01G 4/30

(52) U.S. Cl. CPC H01G 4/2325; H01G 4/008; H01G 4/012; H01G 4/12; H01G 4/30

(57) ABSTRACT

A multilayer electronic component includes a body, an external electrode, a bump electrode, a conductive bonding portion, and a plating layer. The body may include a dielectric layer and an internal electrode alternately disposed with the dielectric layer. The external electrode may be disposed on the body. The bump electrode may be disposed on a lower side of the external electrode. The conductive bonding portion may be disposed between the external electrode and the bump electrode. The conductive bonding portion may be in direct contact with the external electrode and the bump electrode. The conductive bonding portion may include a plurality of first metal particles and a first resin. The plating layer may be disposed to cover an external surface of an external terminal including the external electrode, the bump electrode, and the conductive bonding portion.

### CROSS-REFERENCE TO RELATED APPLICATIONS

This application claims benefit of priority to Korean Patent Application No. 10-2025-0030057 filed on March 7, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a type of multilayer electronic component, may be an important chip component used in industries such as the communication, computing, home appliance, and automobile industries due to having a small size and ensuring high capacitance. In particular, an MLCC may serve as a key passive element in various electrical, electronic, and information communication devices, including mobile phones, computers, and digital TVs. In addition, as MLCCs are used in automobiles and infotainment systems, as demand for high reliability, high strength characteristics, and miniaturization has been increased.

A dielectric layer included in the MLCC may have piezoelectricity and electrostriction. Accordingly, when a DC or AC voltage is applied to the MLCC, a piezoelectric phenomenon may occur between internal electrodes, causing vibrations.

Such vibrations may be transmitted through an external electrode of the MLCC to a printed circuit board on which the MLCC is mounted, resulting in vibration sound. The vibration sound may correspond to an audible frequency in a range of 20 to 20,000 Hz that may cause discomfort to humans. The vibration sound that causes discomfort may be referred to as acoustic noise.

In the related art, a method for reducing acoustic noise may include varying thicknesses of an upper cover portion and a lower cover portion of a body, coupling an interposer including a ceramic material to a lower portion of a capacitor, or coupling a metal bump to the lower portion of the capacitor.

When the metal bump is coupled to the lower portion of the capacitor, the external electrode and the metal bump may be generally coupled to each other using solder including tin (Sn) as a main component, and then a substrate and an electronic component may be fixed using general solder. However, such a fixing method may result in degraded bending strength.

### Prior Art Document

### Patent Document

Patent Document 1: KR Patent Application Publication No. 10-2023-0022782

### SUMMARY

An aspect of the present disclosure is to provide a multilayer electronic component having excellent reliability.

Another aspect of the present disclosure is to provide a multilayer electronic component having improved bending strength.

Another aspect of the present disclosure is to provide a multilayer electronic component having reduced acoustic noise.

However, the aspects of the present disclosure are not limited to those set forth herein and will be more easily understood in the course of describing specific example embodiments of the present disclosure.

According to an aspect of the present disclosure, there is provided a multilayer electronic component including a body including a dielectric layer and an internal electrode alternately disposed with the dielectric layer, an external electrode disposed on the body, a bump electrode disposed on a lower side of the external electrode, a conductive bonding portion disposed between the external electrode and the bump electrode, the conductive bonding portion being in direct contact with the external electrode and the bump electrode, and the conductive bonding portion including a plurality of first metal particles and a first resin, and a plating layer disposed to cover an external surface of an external terminal including the external electrode, the bump electrode, and the conductive bonding portion.

According to example embodiments of the present disclosure, an external electrode and a band portion may be connected to a conductive bonding portion including a plurality of first metal particles and a first resin, thereby improving reliability of a multilayer electronic component.

According to example embodiments of the present disclosure, a multilayer electronic component may have improved bending strength.

According to example embodiments of the present disclosure, a multilayer electronic component may have reduced acoustic noise.

However, the various advantages and effects of the present disclosure are not limited to those set forth herein and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a multilayer electronic component according to an example embodiment of the present disclosure;

FIG. 2 is a bottom perspective view of the multilayer electronic component of FIG. 1;

FIG. 3 is a cross-sectional view taken along line I-I of FIG. 1;

FIG. 4 is a cross-sectional view taken along line II-II of FIG. 1;

FIG. 5 is an exploded perspective view of a body of a multilayer electronic component according to an example embodiment of the present disclosure;

FIG. 6 is an enlarged view of region K1 of FIG. 3; and

FIG. 7 is a view corresponding to FIG. 3 according to another example embodiment.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, an X-direction may be defined as a first direction or a thickness (T) direction, a Y-direction may be defined as a second direction or a length (L) direction, and a Z-direction may be defined as a third direction or a width (W) direction.

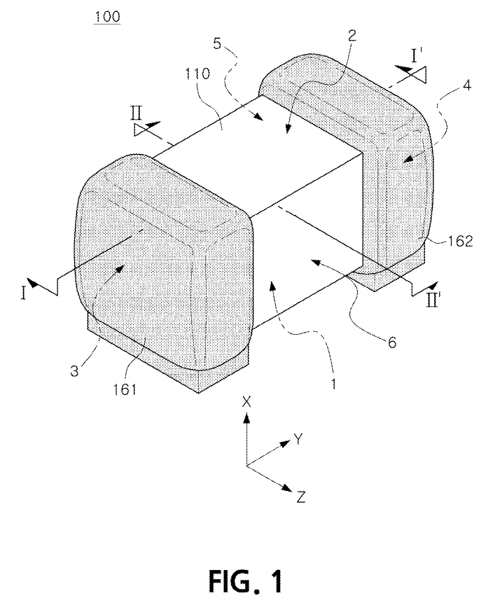

FIG. 1 is a perspective view of a multilayer electronic component according to an example embodiment of the present disclosure.

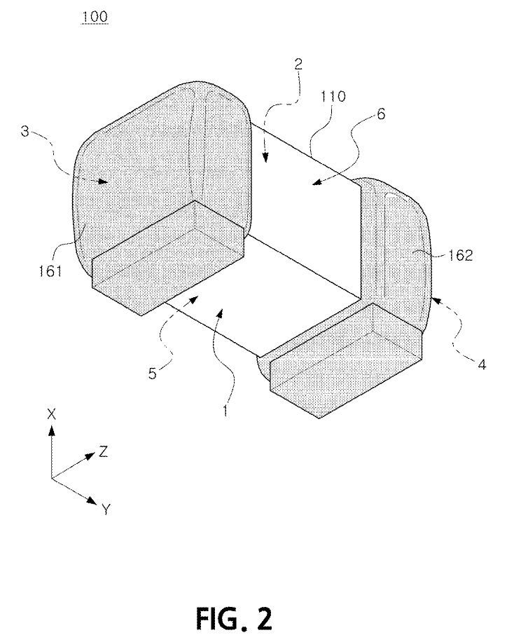

FIG. 2 is a bottom perspective view of the multilayer electronic component of FIG. 1.

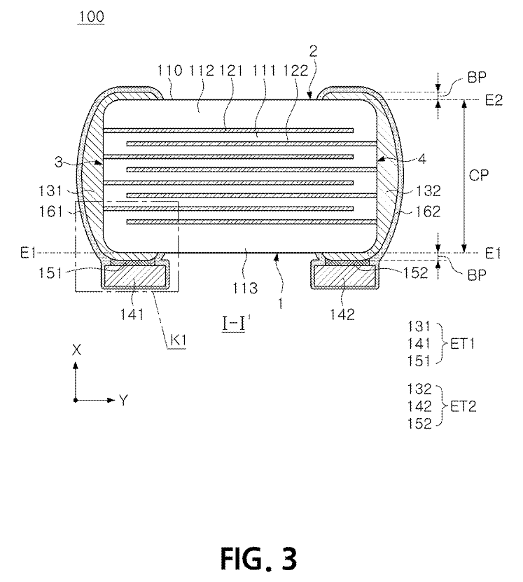

FIG. 3 is a cross-sectional view taken along line I-I of FIG. 1.

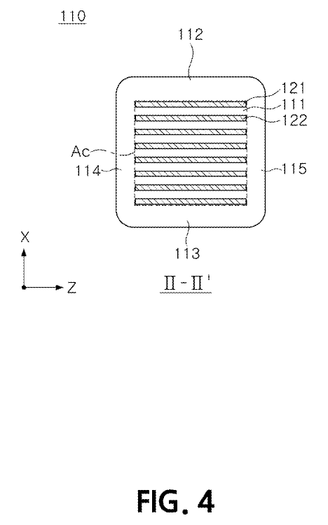

FIG. 4 is a cross-sectional view taken along line II-II of FIG. 1.

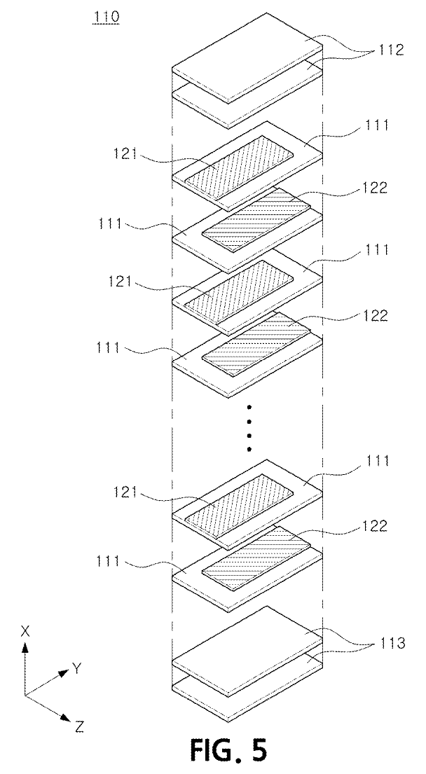

FIG. 5 is an exploded perspective view of a body of a multilayer electronic component according to an example embodiment of the present disclosure.

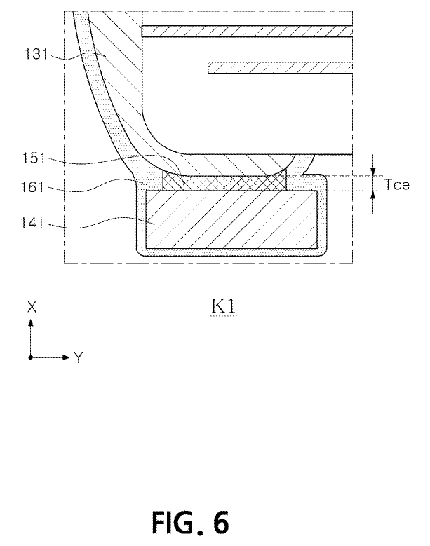

FIG. 6 is an enlarged view of region K1 of FIG. 3.

Hereinafter, a multilayer electronic component 100 according to an example embodiment of the present disclosure will be described in detail with reference to FIGS. 1 to 6.

A multilayer electronic component 100 according to an example embodiment of the present disclosure may include a body 110, external electrodes 131 and 132, bump electrodes 141 and 142, conductive bonding portions 151 and 152, and plating layers 161 and 162. The body 110 ,may include a dielectric layer 111 and internal electrodes 121 and 122 alternately disposed with the dielectric layer 111. The external electrodes 131 and 132 may be disposed on the body 110. The bump electrodes 141 and 142 may be disposed on respective lower sides of the external electrodes 131 and 132. The conductive bonding portions 151 and 152 may be disposed respectively between the external electrodes 131 and 132 and the bump electrodes 141 and 142. The conductive bonding portions 151 and 152 may be in direct contact with the external electrodes 131 and 132 and the bump electrodes 141 and 142. The conductive bonding portions 151 and 152 may include a plurality of first metal particles and a first resin. The plating layers 161 and 162 may be disposed to cover external surfaces of external terminals ET1 and ET2 including the external electrodes 131 and 132, the bump electrodes 141 and 142, and the conductive bonding portions 151 and 152.

A method of coupling a metal bump to a lower portion of a capacitor has been used to reduce acoustic noise.

Generally, an external electrode on which a plating layer is formed and a metal bump on which a plating layer is formed may be generally coupled to each other using solder including Sn as a main component. However, a coupling method using solder may have degraded bending strength.

Accordingly, the present disclosure aims to improve bending strength by coupling an external electrode and a bump electrode to each other using a conductive resin instead of solder including Sn as a main component.

However, coupling the external electrode and the bump electrode to each other using the conductive resin may require a process of curing a resin included in the conductive resin. A curing temperature of the resin may be similar to a melting point of solder including Sn as a main component, but the resin may need to be maintained at the curing temperature for a long period of time to be fully cured. When the external electrode on which the plating layer is formed and the metal bump on which the plating layer is formed are bonded to each other using the conductive resin, a Sn plating layer may form a significant amount of alloy oxide layer during the long curing process, which may degrade a mounting performance improvement effect provided by the Sn plating layer.

Accordingly, in the present disclosure, an external electrode on which no plating layer is formed and a bump electrode on which no plating layer is formed may be coupled to each other using the conductive resin, and a plating layer may be formed after a curing process of the conductive resin, thereby improving bending strength while simultaneously improving mounting characteristics.

The body 110 may include a dielectric layer 111 and internal electrodes 121 and 122 alternately disposed with the dielectric layer. In the body 110, the dielectric layer 111 and the internal electrodes 121 and 122 may be alternately laminated.

A specific shape of the body 110 is not limited. However, as illustrated, the body 110 may have a hexahedral shape or a shape similar thereto. During a sintering process, ceramic powder particles included in the body 110 may shrink, such that the body 110 may not have a hexahedral shape having perfectly straight lines but may have a substantially hexahedral shape.

The body 110 may have first and second surfaces 1 and 2 opposing each other in a thickness direction (i.e. the X-direction), third and fourth surfaces 3 and 4 connected to the first and second surfaces 1 and 2, the third and fourth surfaces 3 and 4 opposing each other in a length direction (i.e. the Y-direction), and fifth and sixth surfaces 5 and 6 connected to the third and fourth surfaces 3 and 4, the fifth and sixth surfaces 5 and 6 opposing each other in a width direction (i.e. the Z-direction).

In an example embodiment, the body 110 includes a first-third corner connecting the first surface 1 and the third surface 3 to each other, a first-fourth corner connecting the first surface 1 and the fourth surface 4 to each other, a second-third corner connecting the second surface 2 and the third surface 3 to each other, and a second-fourth corner connecting the second surface 2 and the fourth surface 4 to each other. The first-third corner and the second-third corner may shrink toward a center portion in a first direction (i.e. the X-direction) of the body 110 as a distance from the third surface 3 decreases, and the first-fourth corner and the second-fourth corner may shrink toward the central portion in the first direction of the body 110 as a distance from the fourth surface 4 decreases.

As margin regions in which the internal electrodes 121 and 122 are not disposed on the dielectric layer 111 overlap each other, a step portion may be caused by thicknesses of the internal electrodes 121 and 122, such that a corner connecting the first surface 1 and the third to fifth surfaces 3, 4, and 5 to each other, and/or a corner connecting the second surface 2 and the third to fifth surfaces 3, 4, and 5 to each other may shrink toward the central portion in the first direction of the body 110 relative to the first surface 1 or the second surface 2. Alternatively, due to shrinkage behavior of the body 110 during a sintering process, a corner, connecting the first surface 1 and the third to sixth surfaces 3, 4, 5, and 6 to each other, and/or a corner, connecting the second surface 2 and the third to sixth surfaces 3, 4, 5, and 6 to each other, may shrink toward the central portion in the first direction of the body 110 relative to the first surface 1 or the second surface 2. Alternatively, in order to prevent chipping defects or the like, an additional process may be performed to round corners connecting respective surfaces 1, 2, 3, 4, 5, and 6 of the body 110 to each other. Accordingly, a corner, connecting the first surface 1 and third to sixth surfaces 3, 4, 5, and 6 to each other, and/or a corner, connecting the second surface 2 and the third to sixth surfaces 3, 4, 5, and 6 to each other, may have a round shape.

The corner may include a first-third corner connecting the first surface 1 and the third surface 3 to each other, a first-fourth corner connecting the first surface 1 and the fourth surface 4 to each other, a second-third corner connecting the second surface 2 and the third surface 3 to each other, and a second-fourth corner connecting the second surface 2 and the fourth surface 4 to each other. In addition, the corner may include a first-fifth corner connecting the first surface 1 and the fifth surface 5 to each other, a first-sixth corner connecting the first surface 1 and the sixth surface 6 to each other, a second-fifth corner connecting the second surface 2 and the fifth surface 5 to each other, and a second-sixth corner connecting the second surface 2 and the sixth surface 6 to each other. The first to sixth surfaces 1, 2, 3, 4, 5, and 6 of the body 110 may be generally flat surfaces, and a region that is not flat may be considered as a corner. Hereinafter, an extension line of each surface 1, 2, 3, 4, 5, and 6 may refer to a line extending relative to a flat portion of each surface 1, 2, 3, 4, 5, and 6.

In order to suppress a step portion caused by the internal electrodes 121 and 122, internal electrodes may be laminated and then cut to be exposed to the fifth and sixth surfaces 5 and 6 of the body. Thereafter, one dielectric layer 111 or two or more dielectric layers 111 may be laminated on both side surfaces of a capacitance formation portion Ac in a third direction (i.e. the width direction and/or the Z-direction) to form margin portions 114 and 115. In this case, a portion connecting the first surface 1 and the fifth and sixth surfaces 5 and 6 to each other, and a portion connecting the second surface 2 and the fifth and sixth surfaces 5 and 6 to each other, may not shrink.

A plurality of dielectric layers 111, included in the body 110, may be in a sintered state, and adjacent dielectric layers 111 may be integrated with each other such that boundaries therebetween are not readily apparent without using a scanning electron microscope (SEM).

According to an example embodiment, a raw material included in the dielectric layer 111 is not limited as long as sufficient capacitance is obtainable therewith. For example, a barium titanate-based material, a lead composite perovskite-based material, or a strontium titanate-based material may be used for the raw material. The barium titanate-based material may include BaTiO₃-based ceramic powder particles. Examples of the ceramic powder may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) obtained by partially dissolving Ca or Zr in BaTiO₃.

In addition, the raw material, included in the dielectric layer 111, may be obtained by adding various ceramic additives, organic solvents, binders, dispersants, or the like to powder particles such as barium titanate (BaTiO₃) depending on the purpose of the present disclosure.

The body 110 may include the capacitance formation portion Ac disposed in the body 110. The capacitance formation portion Ac may have capacitance by including at least one first internal electrode 121 and at least one second internal electrode 122 disposed to oppose each other with the dielectric layer 111 interposed therebetween, and cover portions 112 and 113 disposed on upper and lower portions in the first direction of the capacitance formation portion Ac.

In addition, the capacitance formation portion Ac may be a portion contributing to forming capacitance in a capacitor and may be formed by repeatedly laminating a plurality of first and second internal electrodes 121 and 122 on each other with the dielectric layer 111 interposed therebetween.

The cover portions 112 and 113 may include an upper cover portion 112 disposed on an upper portion in the first direction of the capacitance formation portion Ac, and a lower cover portion 113 disposed on a lower portion in the first direction of the capacitance formation portion Ac.

The upper cover portion 112 and the lower cover portion 113 may be respectively formed by laminating one dielectric layer 111 or two or more dielectric layers 111 on upper and lower surfaces of the capacitance formation portion Ac in the thickness direction and may basically serve to prevent the internal electrodes 121 and 122 from being damaged due to physical or chemical stress.

The upper cover portion 112 and the lower cover portion 113 may not include the internal electrodes 121 and 122, and may include a material the same as that of the dielectric layer 111.

That is, the upper cover portion 112 and the lower cover portion 113 may include a ceramic material, and may include, for example, a barium titanate (BaTiO₃)-based ceramic material.

In addition, the margin portions 114 and 115 may be disposed on side surfaces of the capacitance formation portion Ac, respectively.

The margin portions 114 and 115 may include a first margin portion 114 disposed on the fifth surface 5 of the body 110, and a second margin portion 115 disposed on the sixth surface 6 of the body 110. That is, the margin portions 114 and 115 may be disposed on both end surfaces in the width direction of the body 110, respectively.

As illustrated in FIG. 4, the margin portions 114 and 115 may refer to regions between both ends of each of the first and second internal electrodes 121 and 122 and a boundary surface of the body 110 in a cross-section of the body 110 cut in a width-thickness (W-T) direction.

The margin portions 114 and 115 may basically serve to prevent the internal electrodes 121 and 122 from being damaged due to physical or chemical stress.

The margin portions 114 and 115 may be formed by forming the internal electrodes 121 and 122 by coating a conductive paste on a ceramic green sheet, except for a portion of the ceramic green sheet on which the margin portions 114 and 115 are to be formed.

In addition, in order to suppress a step portion caused by the internal electrodes 121 and 122, the internal electrodes 121 and 122 may be laminated and then cut to be exposed to the fifth and sixth surfaces 5 and 6 of the body 110. Thereafter, one dielectric layer 111 or two or more dielectric layers 111 may be laminated on both side surfaces of the capacitance formation portion Ac in the third direction (width direction) to form the margin portions 114 and 115.

The internal electrodes 121 and 122 may be alternately laminated with the dielectric layer 111.

The internal electrodes 121 and 122 may include a first internal electrode 121 and a second internal electrode 122. The first and second internal electrodes 121 and 122 may be alternately disposed with the dielectric layer 111, included in the body 110, interposed therebetween. The first and second internal electrodes 121 and 122 may be exposed through the third and fourth surfaces 3 and 4 of the body 110, respectively.

Referring to FIG. 3, the first internal electrode 121 may be spaced apart from the fourth surface 4 and exposed through the third surface 3, and the second internal electrode 122 may be spaced apart from the third surface 3 and exposed through the fourth surface 4. The first external electrode 131 may be disposed on the third surface 3 and connected to the first internal electrode 121, and the second external electrode 132 may be disposed on the fourth surface 4 and connected to the second internal electrode 122.

That is, the first internal electrode 121 may not be connected to the second external electrode 132 and may be connected to the first external electrode 131. The second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance.

In this case, the first and second internal electrodes 121 and 122 may be electrically isolated from each other by the dielectric layer 111 interposed therebetween.

The body 110 may be formed by alternately laminating a ceramic green sheet on which the first internal electrode 121 is printed and a ceramic green sheet on which the second internal electrode 122 is printed and then sintering the same.

A material included in the internal electrodes 121 and 122 is not limited, and a material having excellent electrical conductivity may be used. For example, the internal electrodes 121 and 122 may include one or more selected from a group consisting of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing an internal electrode conductive paste including one or more selected from a group consisting of nickel (Ni), copper (Cu), palladium (Pd), silver (Ag), gold (Au), platinum (Pt), tin (Sn), tungsten (W), titanium (Ti), and alloys thereof on a ceramic green sheet. A printing method of the internal electrode conductive paste may be a screen-printing method, a gravure-printing method, or the like, but the present disclosure is not limited thereto.

The external electrodes 131 and 132 may be disposed on the body 110.

The external electrodes 131 and 132 may include a connection portion CP disposed on the third and fourth surfaces 3 and 4, and a band portion BP extending from the connection portion CP to a portion of the first surface 1. Referring to FIG. 3, a region of the external electrodes 131 and 132 disposed between an extension line E1 of the first surface 1 and an extension line E2 of the second surface 2 may be referred to as a connection portion CP, and a region positioned below the extension line E1 of the first surface 1 may be referred to as a band portion BP.

The band portion BP is not limited to being disposed on the first surface 1 and may be disposed to extend from the connection portion CP to one or more of the second, fifth, and sixth surfaces 2, 5, and 6.

The external electrodes 131 and 132 may include a first external electrode 131 and a second external electrode 132. The first external electrode 131 may be disposed on the third surface 3 and connected to the first internal electrode 121, and the second external electrode 132 may be disposed on the fourth surface 4 and connected to the second internal electrode 122.

The bump electrodes 141 and 142 may be disposed on lower sides of the external electrodes 131 and 132.

The bump electrodes 141 and 142 may serve to reduce or absorb vibrations transmitted from a substrate to the multilayer electronic component 100 and may serve to suppress acoustic noise.

The bump electrodes 141 and 142 may include a first bump electrode 141 and a second bump electrode 142. The first bump electrode 141 may be disposed on a lower side of the first external electrode 131 and electrically connected to the first external electrode 131, and the second bump electrode 142 may be disposed on a lower side of the second external electrode 132 and electrically connected to the second external electrode 132.

The conductive bonding portions 151 and 152 may serve to couple the external electrodes 131 and 132 and the bump electrodes 141 and 142 to each other.

The conductive bonding portions 151 and 152 may include a plurality of first metal particles and a first resin. Accordingly, the conductive bonding portions 151 and 152 may improve bending strength by absorbing stress transmitted from the substrate and stress applied from outside the multilayer electronic component 100 and may also electrically connect the external electrodes 131 and 132 and the bump electrodes 141 and 142 to each other.

The conductive bonding portions 151 and 152 may be in direct contact with the external electrodes 131 and 132 and the bump electrodes 141 and 142. Such a structure may be a structure formed by forming the external terminals ET1 and ET2 including the external electrodes 131 and 132, the bump electrodes 141 and 142, and the conductive bonding portions 151 and 152, and then forming the plating layers 161 and 162.

In an example embodiment, a plating layer may not be disposed at an interface between the conductive bonding portions 151 and 152 and the external electrodes 131 and 132, and may be disposed at an interface between the conductive bonding portions 151 and 152 and the bump electrodes 141 and 142.

The conductive bonding portions 151 and 152 may include a first conductive bonding portion 151 and a second conductive bonding portion 152. The first conductive bonding portion 151 may couple the first external electrode 131 and the first bump electrode 141 to each other, and the second conductive bonding portion 152 may couple the second external electrode 132 and the second bump electrode 142 to each other.

The first resin included in the conductive bonding portions 151 and 152 may be a thermosetting resin having electrical insulation properties. In this case, the thermosetting resin may be, for example, an epoxy resin, but the present disclosure is not limited thereto. The thermosetting resin may be, for example, a bisphenol-A resin, a glycol epoxy resin, a novolac epoxy resin, or a resin that is in a liquid state at room temperature due to a low molecular weight thereof, among derivatives thereof.

The first metal particles included in the conductive bonding portions 151 and 152 are not limited, and may include, for example, Cu, Ni, Sn, Pd, Pt, Au, Ag, Pb, and/or an alloy including the same, and more preferably, Cu.

The external terminals ET1 and ET2 may include the external electrodes 131 and 132, the bump electrodes 141 and 142, and the conductive bonding portions 151 and 152. The external terminals ET1 and ET2 may include a first external terminal ET1 and a second external terminal ET2. The first external terminal ET1 may include a first external electrode 131, a first bump electrode 141, and a first conductive bonding portion 151, and the second external terminal ET2 may include a second external electrode 132, a second bump electrode 142, and a second conductive bonding portion 152.

In an example embodiment, the external terminals ET1 and ET2 may not include solder. That is, since solder is not used unlike the related art, the external terminals ET1 and ET2 may include only the external electrodes 131 and 132, the bump electrodes 141 and 142, and the conductive bonding portions 151 and 152.

The plating layers 161 and 162 may be disposed to cover the external terminals ET1 and ET2 including the external electrodes 131 and 132, the bump electrodes 141 and 142, and the conductive bonding portions 151 and 152. In this case, the plating layers 161 and 162 may be disposed to be in direct contact with the external electrodes 131 and 132 and the bump electrodes 141 and 142. In addition, the plating layers 161 and 162 may be disposed to be in direct contact with the conductive bonding portions 151 and 152.

The plating layers 161 and 162 may include a first plating layer 161 and a second plating layer 162. The first plating layer 161 may cover the first external terminal ET1, and the second plating layer 162 may cover the second external terminal ET2.

The plating layers 161 and 162 may serve to improve mounting characteristics.

In an example embodiment, the plating layers 161 and 162 may include a Ni plating layer in contact with externals surfaces of the external terminals ET1 and ET2, and an Sn plating layer disposed on the Ni plating layer.

In an example embodiment, the external electrodes 131 and 132 may include a conductive metal and glass. The external electrodes 131 and 132 may be sintered electrodes formed by dipping the body 110 into a paste including a conductive metal and glass and then sintering the same.

In this case, one or more of the plurality of first metal particles included in the conductive bonding portions 151 and 152 may be disposed to be in direct contact with at least a portion of the conductive metal included in the external electrodes 131 and 132.

A material having excellent electrical conductivity may be used as the conductive metal included in the external electrodes 131 and 132, but the present disclosure is not limited thereto. For example, the conductive metal may be one or more selected from a group consisting of nickel (Ni), copper (Cu), and alloys thereof.

In an example embodiment, the external electrodes 131 and 132 may include second metal particles and a second resin. The external electrodes 131 and 132 may be conductive resin layers formed by dipping the body 110 into a paste including second metal particles and a second resin and then curing the same. Alternatively, the external electrodes 131 and 132 may have a two-layered structure in which the body 110 is dipped into a paste including a conductive metal and glass, sintered to form a sintered electrode, and then dipped into a paste including second metal particles and a second resin and then cured to form a conductive resin layer.

In this case, one or more of the plurality of first metal particles included in the conductive bonding portions 151 and 152 may be disposed to be in direct contact with one or more of the plurality of second metal particles included in the external electrodes 131 and 132.

The second resin included in the external electrodes 131 and 132 may be a thermosetting resin having electrical insulation properties. In this case, the thermosetting resin may be, for example, an epoxy resin, but the present disclosure is not limited thereto. The thermosetting resin may be, for example, bisphenol A resin, a glycol epoxy resin, a novolac epoxy resin, or a resin that is in a liquid state at room temperature due to a low molecular weight thereof, among derivatives thereof.

The second metal particles included in the external electrodes 131 and 132 are not limited and may include, for example, Cu, Ni, Sn, Pd, Pt, Au, Ag, Pb, and/or an alloy including the same. More preferably, the second metal particles included in the external electrodes 131 and 132 may include one or more selected from a group consisting of Cu, Ag, Sn, and alloys thereof.

In an example embodiment, the external electrodes 131 and 132 and the bump electrodes 141 and 142 may not include a plating layer. The external electrodes 131 and 132 on which no plating layer is formed and the bump electrodes 141 and 142 on which no plating layer is formed may be coupled to each other using the conductive bonding portions 151 and 152, and the plating layers 161 and 162 may be formed after a curing process of the conductive bonding portions 151 and 152, thereby improving bending strength and improving mounting characteristics.

An average thickness (Tce) of each of the conductive bonding portions 151 and 152 is not limited. For example, the average thickness (Tce) of each of the conductive bonding portions 151 and 152 may be 5 µm to 20 µm. When the average thickness (Tce) of each of the conductive bonding portions 151 and 152 is less than 5 μm, sufficient coupling force between the external electrodes 131 and 132 and the bump electrodes 141 and 142 may not be secured, or a bending strength improvement effect may be insufficient. When the average thickness (Tce) is greater than 20 μm, equivalent serial resistance (ESR) may be increased, thereby degrading electrical characteristics.

The average thickness (Tce) of the conductive bonding portions 151 and 152 may be measured in a cross section in a length direction cut from the center in the width direction of the multilayer electronic component 100 and may be an average value measured at five points having an equal interval in the length direction.

In an example embodiment, the body 110 includes the first and second surfaces 1 and 2 opposing each other in the thickness direction, the third and fourth surfaces 3 and 4 opposing each other in the length direction, and the fifth and sixth surfaces 5 and 6 opposing each other in the width direction, the external electrodes 131 and 132 include a connection portion CP disposed on the third and fourth surfaces 3 and 4 and a band portion BP extending from the connection portion CP to a portion of the first surface 1, and the conductive bonding portions 151 and 152 may be disposed on a lower side of the band portion BP.

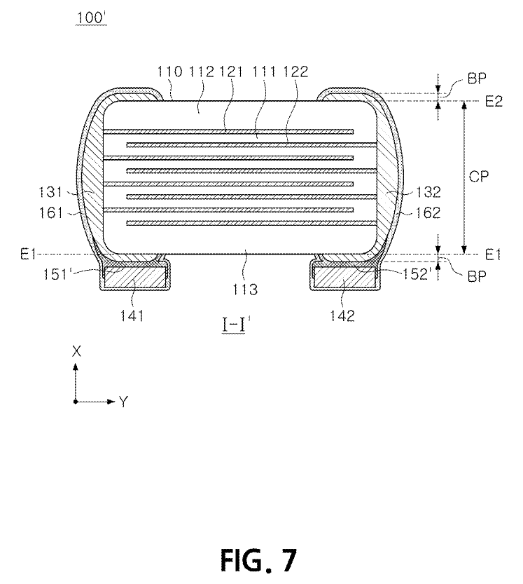

FIG. 7 is a view, corresponding to FIG. 3, of a multilayer electronic component 100’ according to another example embodiment.

Referring to FIG. 7, conductive bonding portions 151’ and 152’ may be disposed to extend to a space between plating layers 161 and 162 and at least a portion of connection portions CP of external electrodes 131 and 132. That is, a first conductive bonding portion 151’ may be disposed to extend to a space between a first plating layer 161 and at least a portion of a connection portion CP of a first external electrode 131, and the second conductive bonding portion 152’ may be disposed to extend to a space between a second plating layer 162 and at least a portion of a connection portion CP of a second external electrode 132.

In addition, the conductive bonding portions 151’ and 152’ may be disposed to extend to a space between the plating layers 161 and 162 and at least a portion of side surfaces of bump electrodes 141 and 12. That is, the first conductive bonding portion 151’ may be disposed to extend to a space between the first plating layer 161 and at least a portion of a side surface of a first bump electrode 141, and the second conductive bonding portion 152’ may be disposed to extend to a space between the second plating layer 162 and at least a portion of a side surface of the second bump electrode 142.

The bump electrodes 141 and 142 may be formed of any material having electrical conductivity such as a metal, and a specific material may be determined in consideration of electrical characteristics, structural stability, or the like. For example, the bump electrodes 141 and 142 may include Cu. More specifically, the bump electrodes 141 and 142 may be substantially formed of Cu.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are merely used to describe a specific example embodiment and are not intended to limit the present disclosure. Singular forms may include plural forms as well unless the context clearly indicates otherwise.

Throughout the specification and claims, range limitations are combined and/or interchanged. Such ranges are identified and include all the sub-ranges contained therein unless context or language indicates otherwise. For example, all ranges disclosed herein are inclusive of the endpoints, and the endpoints are independently combinable with each other.

What is claimed is:

1. A multilayer electronic component comprising:
a body including a dielectric layer and an internal electrode alternately disposed with the dielectric layer;
an external electrode disposed on the body;
a bump electrode disposed on a lower side of the external electrode;
a conductive bonding portion disposed between the external electrode and the bump electrode, the conductive bonding portion being in direct contact with the external electrode and the bump electrode, and the conductive bonding portion including a plurality of first metal particles and a first resin; and
a plating layer disposed to cover an external surface of an external terminal including the external electrode, the bump electrode, and the conductive bonding portion.

2. The multilayer electronic component of claim 1, wherein the plating layer is disposed to be in direct contact with the external electrode and the bump electrode.

3. The multilayer electronic component of claim 1, wherein the external electrode includes a conductive metal and glass.

4. The multilayer electronic component of claim 3, wherein one or more of the plurality of first metal particles are disposed to be in direct contact with at least a portion of the conductive metal.

5. The multilayer electronic component of claim 1, wherein the external electrode includes a plurality of second metal particles and a second resin.

6. The multilayer electronic component of claim 5, wherein one or more of the plurality of first metal particles are disposed to be in direct contact with one or more of the plurality of second metal particles.

7. The multilayer electronic component of claim 1, wherein the external electrode and the bump electrode do not include the plating layer.

8. The multilayer electronic component of claim 1, wherein the conductive bonding portion has an average thickness of 5 μm to 20 μm.

9. The multilayer electronic component of claim 1, wherein
the body includes first and second surfaces opposing each other in a thickness direction, third and fourth surfaces opposing each other in a length direction, and fifth and sixth surfaces opposing each other in a width direction,
the external electrode includes a connection portion disposed on the third and fourth surfaces, and a band portion extending from the connection portion to a portion of the first surface, and
the conductive bonding portion is disposed on a lower side of the band portion.

10. The multilayer electronic component of claim 9, wherein the conductive bonding portion is disposed to extend to a space between the plating layer and at least a portion of the connection portion of the external electrode.

11. The multilayer electronic component of claim 9, wherein the conductive bonding portion is disposed to extend to a space between the plating layer and at least a portion of a side surface of the bump electrode.

12. The multilayer electronic component of claim 1, wherein the plating layer includes a Ni plating layer in contact with the external surface of the external terminal, and a Sn plating layer disposed on the Ni plating layer.

13. The multilayer electronic component of claim 1, wherein the bump electrode includes Cu.

14. The multilayer electronic component of claim 1, wherein the first metal particles include Cu.

15. The multilayer electronic component of claim 1, wherein the external terminal does not include solder.

16. The multilayer electronic component of claim 1, wherein the plating layer is not disposed at an interface between the conductive bonding portion and the external electrode or at an interface between the conductive bonding portion and the bump electrode.
